(19) United States
(12) Patent Application Publication
(10) Pub. No.: US 2022/0113554 A1
(43) Pub. Date: Apr. 14, 2022

(54) MULTIVIEW BACKLIGHT, DISPLAY, AND METHOD HAVING A MULTIBEAM ELEMENT WITHIN A LIGHT GUIDE

(71) Applicant: LEIA INC., Menlo Park, CA (US)

(72) Inventors: David A. Fattal, Menlo Park, CA (US); Ming Ma, Menlo Park, CA (US)

(21) Appl. No.: 17/555,268

(22) Filed: Dec. 17, 2021

Related U.S. Application Data
(63) Continuation of application No. PCT/US2019/041481, filed on Jul. 11, 2019.

(51) Int. Cl. G02B 30/33; F21V 8/00; G02B 5/02

(52) U.S. Cl. CPC G02B 30/33; G02B 5/0252; G02B 5/0278; G02B 6/0036

(57) ABSTRACT

A multiview backlight having applications in a multiview display employs an array of multibeam elements located a predetermined distance below a top surface of a light guide in the multiview backlight. The multibeam elements may be configured to scatter out through the top surface a portion of guided light from the light guide as directional light beams having different principal angular directions corresponding to different views of the multiview display. For example, the multibeam elements each may comprise one or more of a diffraction grating, a micro-reflective element, and a micro-refractive element. Moreover, the multiview display may include an array of light valves configured to modulate the directional light beams as a multiview image to be displayed by the multiview display, and the predetermined distance may be greater than one quarter of a size of a light valve of the set of light valves.

### CROSS-REFERENCE TO RELATED APPLICATIONS

This application is a continuation application of and claims priority to International Patent Application No. PCT/US2019/041481, filed on Jul. 11, 2019, the contents of which are herein incorporated by reference.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of angular components of a light beam having a particular principal angular direction corresponding to a view direction of a multiview display in an example, according to an embodiment consistent with the principles described herein.

FIG. 2 illustrates a cross-sectional view of a diffraction grating in an example, according to an embodiment consistent with the principles described herein.

FIG. 3A illustrates a cross-sectional view of a multiview backlight in an example, according to an embodiment consistent with the principles described herein.

FIG. 3B illustrates a plan view of a multiview backlight in an example, according to an embodiment consistent with the principles described herein.

FIG. 3C illustrates a perspective view of a multiview backlight in an example, according to an embodiment consistent with the principles described herein.

FIG. 4 illustrates a cross-sectional view of a multiview backlight in an example, according to an embodiment consistent with the principles described herein.

FIG. 5 illustrates a cross-sectional view of a multiview display in an example, according to an embodiment consistent with the principles described herein.

FIG. 6A illustrates a cross-sectional view of a multibeam element in an example, according to an embodiment consistent with the principles described herein.

FIG. 6B illustrates a cross-sectional view of a multibeam element in an example, according to an embodiment consistent with the principles described herein.

FIG. 7 illustrates a block diagram of a multiview display in an example, according to an embodiment consistent with the principles described herein.

FIG. 8 illustrates a flow chart of a method of multiview backlight operation in an example, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a multiview backlight having applications in a multiview or three-dimensional (3D) display. Notably, the multiview backlight employs a plurality of multibeam elements located a predetermined distance below a first or top surface of a light guide in the multiview backlight. The multibeam elements may be configured to scatter out through the top surface a portion of guided light from the light guide as a plurality of directional light beams having different principal angular directions corresponding to different views of the multiview display. According to various embodiments, the multibeam elements each comprise one or more of a diffraction grating, a micro-reflective element, and a micro-refractive element. Moreover, according to various embodiments, the multiview display includes an array of light valves configured to modulate the directional light beams as a multiview image to be displayed by the multiview display, where a multiview pixel of the multiview display includes a set of light valves of the light valve array corresponding to a multibeam element of the multibeam element plurality and being configured to modulate the directional light beams from the multibeam element. In some embodiments, locating the multibeam elements below the top surface of the light guide may provide a viewing distance of the multiview display that is reduced compared to locating the multibeam elements on a back surface of the light guide. Furthermore, in some embodiments, the predetermined distance may be greater than one quarter (25%) of a size of a light valve of the array of light valves.

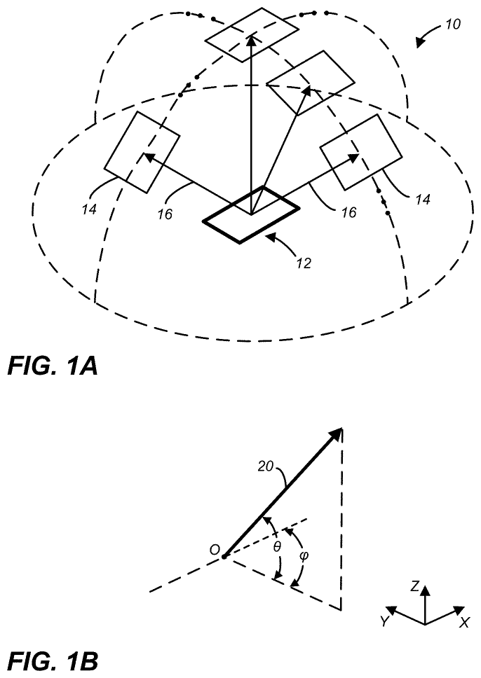

Herein, a ‘multiview display’ is defined as an electronic display or display system configured to provide different views of a multiview image in different view directions. FIG. 1A illustrates a perspective view of a multiview display 10 in an example, according to an embodiment consistent with the principles described herein. As illustrated in FIG. 1A, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions; the different views 14 are illustrated as polygonal boxes at the termination of the arrows (i.e., depicting the view directions 16); and only four views 14 and four view directions 16 are illustrated, all by way of example and not limitation. Note that while the different views 14 are illustrated in FIG. 1A as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction (i.e., a directional light beam) corresponding to a view direction of a multiview display generally has a principal angular direction given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane). FIG. 1B illustrates a graphical representation of the angular components {θ, ϕ} of a light beam 20 having a particular principal angular direction corresponding to a view direction (e.g., view direction 16 in FIG. 1A) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin O.

Further herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set or group of light valves of a light valve array that represent view pixels in each view of a plurality of different views of a multiview display. In particular, a multiview pixel may have an individual light valve of the light valve array corresponding to or representing a view pixel in each of the different views of the multiview image. Moreover, the view pixels provided by light valves of the multiview pixel are so-called ‘directional pixels’ in that each of the view pixels is associated with a predetermined view direction of a corresponding one of the different views, by definition herein. Further, according to various examples and embodiments, the different view pixels represented by the light valves of a multiview pixel may have equivalent or at least substantially similar locations or coordinates in each of the different views. For example, a first multiview pixel may have individual light valves corresponding to view pixels located at {x₁, y₁} in each of the different views of a multiview image, while a second multiview pixel may have individual light valves corresponding to view pixels located at {x₂, y₂} in each of the different views, and so on.

In some embodiments, a number of light valves in a multiview pixel may be equal to a number of different views of the multiview display. For example, the multiview pixel may provide sixty-four (64) light valves in association with a multiview display having 64 different views. In another example, the multiview display may provide an eight by four array of views (i.e., 32 views) and the multiview pixel may include thirty-two 32 light valves (i.e., one for each view). Additionally, each different light valve may provide a view pixel having an associated direction (e.g., light beam principal angular direction) that corresponds to a different one of the view directions of the different views, for example. Further, according to some embodiments, a number of multiview pixels of the multiview display may be substantially equal to a number of view pixels (i.e., pixels that make up a selected view) in a multiview image.

Herein, a ‘light guide’ is defined as a structure that guides light within the structure using total internal reflection. In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a first or top surface and a second or bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

Herein, a ‘diffraction grating’ is broadly defined as a plurality of features (i.e., diffractive features) arranged to provide diffraction of light incident on the diffraction grating. In some examples, the plurality of features may be arranged in a periodic manner or a quasi-periodic manner. In other examples, the diffraction grating may be a mixed-period diffraction grating that includes a plurality of diffraction gratings, each diffraction grating of the plurality having a different periodic arrangement of features. Further, the diffraction grating may include a plurality of features (e.g., a plurality of grooves or ridges in a material surface) arranged in a one-dimensional (1D) array. Alternatively, the diffraction grating may comprise a two-dimensional (2D) array of features or an array of features that are defined in two dimensions. The diffraction grating may be a 2D array of bumps on or holes in a material surface, for example. In some examples, the diffraction grating may be substantially periodic in a first direction or dimension and substantially aperiodic (e.g., constant, random, etc.) in another direction across or along the diffraction grating.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from the light guide.

Further, by definition herein, the features of a diffraction grating are referred to as ‘diffractive features’ and may be one or more of at, in and on a material surface (i.e., a boundary between two materials). The surface may be below a first or top surface of a light guide, for example. The diffractive features may include any of a variety of structures that diffract light including, but not limited to, one or more of grooves, ridges, holes and bumps at, in or on the surface. For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a diffractive multibeam element, as described below) may be employed to diffractively scatter or couple light out of a light guide (e.g., a plate light guide) as a light beam. In particular, a diffraction angle θₘ of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, d is a distance or spacing between features of the diffraction grating, θᵢ is an angle of incidence of light on the diffraction grating. For simplicity, equation (1) assumes that the diffraction grating is adjacent to a surface of the light guide and a refractive index of a material outside of the light guide is equal to one (i.e., nₒᵤₜ=1). In general, the diffraction order m is given by an integer (i.e., m=+1, +2, . . . ). A diffraction angle θₘ of a light beam produced by the diffraction grating may be given by equation (1). First-order diffraction or more specifically a first-order diffraction angle θₘ is provided when the diffraction order m is equal to one (i.e., m=1).

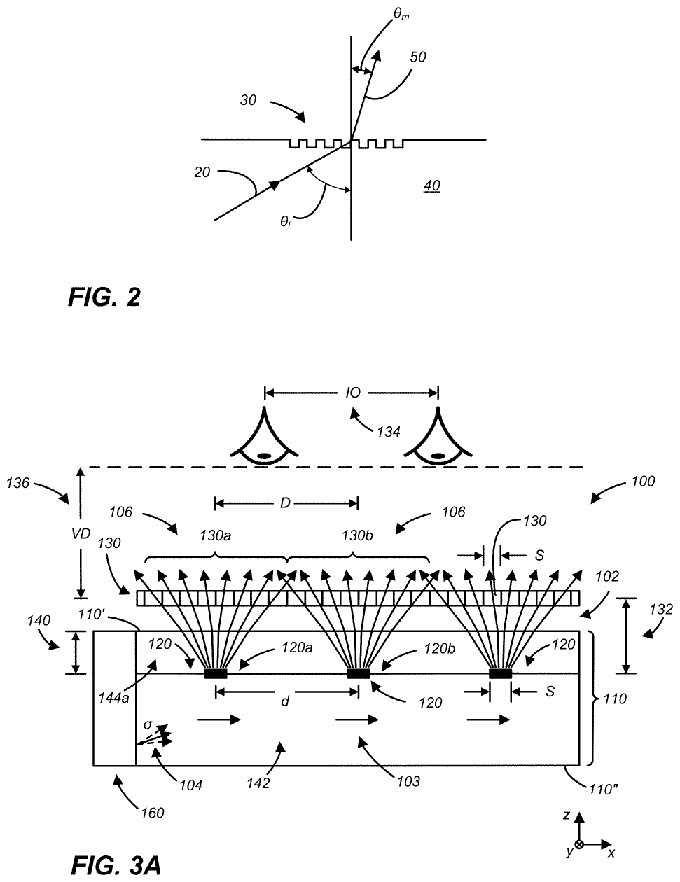

FIG. 2 illustrates a cross-sectional view of a diffraction grating 30 in an example, according to an embodiment consistent with the principles described herein. For example, the diffraction grating 30 may be located on a surface of a light guide 40. In addition, FIG. 2 illustrates a light beam 20 incident on the diffraction grating 30 at an incident angle θᵢ. The light beam 20 is a guided light beam within the light guide 40. Also illustrated in FIG. 2 is a directional light beam 50 diffractively produced and coupled-out or scattered-out by the diffraction grating 30 as a result of diffraction of the incident light beam 20. The directional light beam 50 has a diffraction angle θₘ (or ‘principal angular direction’ herein) as given by equation (1). The directional light beam 50 may correspond to a diffraction order ‘m’ of the diffraction grating 30, for example.

Further, the diffractive features may be curved and may also have a predetermined orientation (e.g., a slant or a rotation) relative to a propagation direction of light, according to some embodiments. One or both of the curve of the diffractive features and the orientation of the diffractive features may be configured to control a direction of light coupled-out by the diffraction grating, for example. For example, a principal angular direction of the directional light may be a function of an angle of the diffractive feature at a point at which the light is incident on the diffraction grating relative to a propagation direction of the incident light.

By definition herein, a ‘multibeam element’ is a structure or element of a backlight or a display that produces light that includes a plurality of light beams. A ‘diffractive’ multibeam element is a multibeam element that produces the plurality of light beams by or using diffractive coupling, by definition. In particular, in some embodiments, the diffractive multibeam element may be optically coupled to a light guide of a backlight to provide the plurality of light beams by diffractively coupling out a portion of light guided in the light guide. Further, by definition herein, a diffractive multibeam element comprises a plurality of diffraction gratings within a boundary or extent of the multibeam element. The light beams of the plurality of light beams (or ‘light beam plurality’) produced by a multibeam element have different principal angular directions from one another, by definition herein. In particular, by definition, a light beam of the light beam plurality has a predetermined principal angular direction that is different from another light beam of the light beam plurality. According to various embodiments, the spacing or grating pitch of diffractive features in the diffraction gratings of the diffractive multibeam element may be sub-wavelength (i.e., less than a wavelength of the guided light).

While a multibeam element with a plurality of diffraction gratings is used as an illustrative example in the discussion that follows, in some embodiments other components may be used in multibeam element, such as at least one of a micro-reflective element and a micro-refractive element. For example, the micro-reflective element may include a triangular-shaped mirror, a trapezoid-shaped mirror, a pyramid-shaped mirror, a rectangular-shaped mirror, a hemispherical-shaped mirror, a concave mirror and/or a convex mirror. In some embodiments, a micro-refractive element may include a triangular-shaped refractive element, a trapezoid-shaped refractive element, a pyramid-shaped refractive element, a rectangular-shaped refractive element, a hemispherical-shaped refractive element, a concave refractive element and/or a convex refractive element.

According to various embodiments, the light beam plurality may represent a light field. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field.

According to various embodiments, the different principal angular directions of the various light beams in the light beam plurality are determined by a characteristic including, but not limited to, a size (e.g., one or more of length, width, area, and etc.) of the diffractive multibeam element along with a ‘grating pitch’ or a diffractive feature spacing and an orientation of a diffraction grating within diffractive multibeam element. In some embodiments, the diffractive multibeam element may be considered an ‘extended point light source’, i.e., a plurality of point light sources distributed across an extent of the diffractive multibeam element, by definition herein. Further, a light beam produced by the diffractive multibeam element has a principal angular direction given by angular components {θ, ϕ}, by definition herein, and as described above with respect to FIG. 1B.

Herein a ‘collimator’ is defined as substantially any optical device or apparatus that is configured to collimate light. For example, a collimator may include, but is not limited to, a collimating mirror or reflector, a collimating lens, or various combinations thereof. In some embodiments, the collimator comprising a collimating reflector may have a reflecting surface characterized by a parabolic curve or shape. In another example, the collimating reflector may comprise a shaped parabolic reflector. By ‘shaped parabolic’ it is meant that a curved reflecting surface of the shaped parabolic reflector deviates from a ‘true’ parabolic curve in a manner determined to achieve a predetermined reflection characteristic (e.g., a degree of collimation). Similarly, a collimating lens may comprise a spherically shaped surface (e.g., a biconvex spherical lens).

In some embodiments, the collimator may be a continuous reflector or a continuous lens (i.e., a reflector or lens having a substantially smooth, continuous surface). In other embodiments, the collimating reflector or the collimating lens may comprise a substantially discontinuous surface such as, but not limited to, a Fresnel reflector or a Fresnel lens that provides light collimation. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments.

Herein, a ‘collimation factor,’ denoted σ, is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein, the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

Further, as used herein, the article ‘a’ is intended to have its ordinary meaning in the patent arts, namely ‘one or more’. For example, ‘an element’ means one or more elements and as such, ‘the element’ means ‘the element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

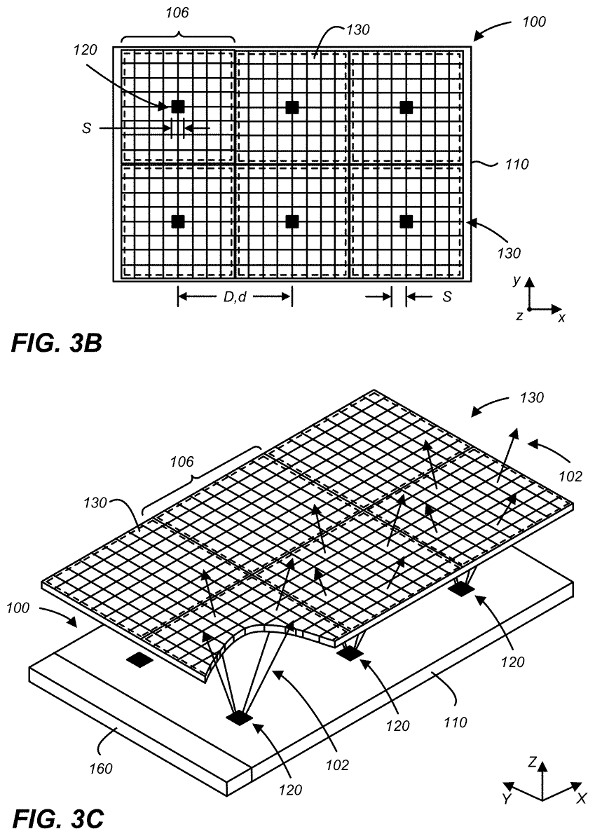

According to some embodiments of the principles described herein, a multiview backlight is provided. FIG. 3A illustrates a cross-sectional view of a multiview backlight 100 in an example, according to an embodiment consistent with the principles described herein. FIG. 3B illustrates a plan view of a multiview backlight 100 in an example, according to an embodiment consistent with the principles described herein. FIG. 3C illustrates a perspective view of a multiview backlight 100 in an example, according to an embodiment consistent with the principles described herein. The perspective view in FIG. 3C is illustrated with a partial cut-away to facilitate discussion herein only.

The multiview backlight 100 illustrated in FIGS. 3A-3C is configured to provide a plurality of directional light beams 102 having different principal angular directions from one another (e.g., as a light field). In particular, the provided plurality of directional light beams 102 are scattered out and directed away from the multiview backlight 100 in different principal angular directions corresponding to respective view directions of a multiview display that includes the multiview backlight 100, according to various embodiments. In some embodiments, the directional light beams 102 may be modulated (e.g., using light valves of the multiview display, as described below) to facilitate the display of information having multiview content, e.g., a multiview image. FIGS. 3A-3C also illustrate a multiview pixel 106 comprising an array of light valves 130 of the multiview display, described in further detail below.

As illustrated in FIGS. 3A-3C, the multiview backlight 100 comprises a light guide 110. The light guide 110 is configured to guide light along a length of the light guide 110 as guided light 104 (i.e., a guided light beam 104). For example, the light guide 110 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 104 according to one or more guided modes of the light guide 110, for example. In some embodiments, the light guide 110 includes a first material layer 142 and a second material layer 144a disposed on a surface of the first material layer 142 and having an index of refraction that matches the index of refraction of the first material layer 142.

Moreover, in some embodiments, the light guide 110 may be a slab or plate optical waveguide (i.e., a plate light guide) comprising an extended, substantially planar sheet of optically transparent, dielectric material. The substantially planar sheet of dielectric material is configured to guide the guided light 104 using total internal reflection. According to various examples, the optically transparent material of the light guide 110 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 110 may further include a cladding layer (not illustrated) on at least a portion of a surface (e.g., one or both of the top surface and the bottom surface) of the light guide 110. The cladding layer may be used to further facilitate total internal reflection, according to some examples.

Further, according to some embodiments, the light guide 110 is configured to guide the guided light 104 according to total internal reflection at a non-zero propagation angle between a first surface 110′ (e.g., ‘front’ or ‘top’ surface or side) and a second surface 110″ (e.g., ‘back’ surface or side) of the light guide 110. In particular, the guided light 104 propagates by reflecting or ‘bouncing’ between the first surface 110′ and the second surface 110″ of the light guide 110 at the non-zero propagation angle. In some embodiments, a plurality of guided light beams comprising different colors of light may be guided by the light guide 110 as the guided light 104 at respective ones of different color-specific, non-zero propagation angles. Note, the non-zero propagation angle is not illustrated in FIGS. 3A-3C for simplicity of illustration. However, a bold arrow depicting a propagation direction 103 illustrates a general propagation direction of the guided light 104 along the light guide length in FIG. 3A.

As defined herein, a ‘non-zero propagation angle’ is an angle relative to a surface (e.g., the first surface 110′ or the second surface 110″) of the light guide 110. Further, the non-zero propagation angle is both greater than zero and less than a critical angle of total internal reflection within the light guide 110, according to various embodiments. For example, the non-zero propagation angle of the guided light 104 may be between about ten (10) degrees and about fifty (50) degrees or, in some examples, between about twenty (20) degrees and about forty (40) degrees, or between about twenty-five (25) degrees and about thirty-five (35) degrees. For example, the non-zero propagation angle may be about thirty (30) degrees. In other examples, the non-zero propagation angle may be about 20 degrees, or about 25 degrees, or about 35 degrees. Moreover, a specific non-zero propagation angle may be chosen (e.g., arbitrarily) for a particular implementation as long as the specific non-zero propagation angle is chosen to be less than the critical angle of total internal reflection within the light guide 110.

The guided light 104 in the light guide 110 may be introduced or coupled into the light guide 110 at the non-zero propagation angle (e.g., about 30-35 degrees). In some examples, a coupling structure such as, but not limited to, a lens, a mirror or similar reflector (e.g., a tilted collimating reflector), a diffraction grating and a prism (not illustrated) as well as various combinations thereof may facilitate coupling light into an input end of the light guide 110 as the guided light 104 at the non-zero propagation angle. In other examples, light may be introduced directly into the input end of the light guide 110 either without or substantially without the use of a coupling structure (i.e., direct or ‘butt’ coupling may be employed). Once coupled into the light guide 110, the guided light 104 is configured to propagate along the light guide 110 in a propagation direction 103 that may be generally away from the input end (e.g., illustrated by bold arrows pointing along an x-axis in FIG. 3A).

Further, the guided light 104, or equivalently the guided light beam 104, produced by coupling light into the light guide 110 may be a collimated light beam, according to various embodiments. Herein, a ‘collimated light’ or a ‘collimated light beam’ is generally defined as a beam of light in which rays of the light beam are substantially parallel to one another within the light beam (e.g., the guided light beam 104). Also, by definition herein, rays of light that diverge or are scattered from the collimated light beam are not considered to be part of the collimated light beam. In some embodiments (not illustrated), the multiview backlight 100 may include a collimator, such as a lens, reflector or mirror, as described above, (e.g., tilted collimating reflector) to collimate the light, e.g., from a light source. In some embodiments, the light source itself comprises a collimator. The collimated light provided to and guided by the light guide 110 as the guided light 104 may be a collimated guided light beam. In particular, the guided light 104 may be collimated according to or having a collimation factor 6, in various embodiments. Alternatively, the guided light 104 may be uncollimated, in other embodiments.

As illustrated in FIGS. 3A-3C, the multiview backlight 100 further comprises a plurality of multibeam elements 120 a predetermined distance 140 below the first (front or top) surface 110′ of the light guide 110. For example, the multibeam elements 120 may be disposed on a surface of the first material layer 142. Moreover, the multibeam elements 120 are spaced apart from one another along the light guide length. In particular, the multibeam elements 120 of the plurality are separated from one another by a finite space and represent individual, distinct elements along the light guide length. That is, by definition herein, the multibeam elements 120 of the plurality are spaced apart from one another according to a finite (i.e., non-zero) inter-element distance (e.g., a finite center-to-center distance). Further, the multibeam elements 120 of the plurality generally do not intersect, overlap or otherwise touch one another, according to some embodiments. That is, each multibeam element 120 of the plurality is generally distinct and separated from other ones of the multibeam elements 120.

According to some embodiments, the multibeam elements 120 of the plurality may be arranged in either a one-dimensional (1D) array or a two-dimensional (2D) array. For example, the multibeam elements 120 may be arranged as a linear 1D array. In another example, the multibeam elements 120 may be arranged as a rectangular 2D array or as a circular 2D array. Further, the array (i.e., 1D or 2D array) may be a regular or uniform array, in some examples. In particular, an inter-element distance (e.g., center-to-center distance or spacing) between the multibeam elements 120 may be substantially uniform or constant across the array. In other examples, the inter-element distance between the multibeam elements 120 may be varied one or both of across the array and along the length of the light guide 110.

According to various embodiments, a multibeam element 120 of the multibeam element plurality is configured to provide, couple out or scatter out a portion of the guided light 104 as the plurality of directional light beams 102. For example, the guided light portion may be coupled out or scattered out using one or more of diffractive scattering, reflective scattering, and refractive scattering or coupling, according to various embodiments. FIGS. 3A and 3C illustrate the directional light beams 102 as a plurality of diverging arrows depicted as being directed way from the first (or front) surface 110′ of the light guide 110. Further, according to various embodiments, a size of the multibeam element 120 is comparable to a size of a light valve 130 of a multiview pixel 106, as defined above and further described below and illustrated in FIGS. 3A-3C. Herein, the ‘size’ may be defined in any of a variety of manners to include, but not be limited to, a length, a width or an area. For example, the size of a light valve 130 may be a length thereof and the comparable size of the multibeam element 120 may also be a length of the multibeam element 120. In another example, the size may refer to an area such that an area of the multibeam element 120 may be comparable to an area of the light valve 130.

In some embodiments, the light valve 130 may be defined as a single aperture (e.g., a color sub-pixel) within the light valve array and the light valve size may refer to the size of the single aperture or equivalently to a spacing between apertures (e.g., a center-to-center spacing). In other embodiments, the light valve 130 may comprise a set of apertures arranged in a group and representing different color sub-pixels of the light valve (e.g., a light valve comprising one each of a red (R) color sub-pixel, a green (G) color sub-pixel, and a blue (B) color sub-pixel of an RGB light valve). In these embodiments, the light valve size may be a defined as a size (e.g., center-to-center spacing) of the set of the apertures comprising each of different color sub-pixels of the light valve (e.g., the set including each of an R, G, and B color sub-pixel arranged together as the RGB light valve).

In some embodiments, the size of the multibeam element 120 is comparable to the light valve size such that the multibeam element size is between about 25 percent (25%) or one quarter and about two hundred percent (200%) or two times of the light valve size. For example, if the multibeam element size is denoted ‘s’ and the light valve size is denoted ‘S’ (e.g., as illustrated in FIG. 3A), then the multibeam element size s may be given by

¼S≤s≤2S

In other examples, the multibeam element size is in a range that is greater than about fifty percent (50%) of the light valve size, or greater than about seventy percent (70%) of the light valve size, or greater than about eighty percent (80%) of the light valve size, or greater than about ninety percent (90%) of the light valve size, and that is less than about one hundred eighty percent (180%) of the light valve size, or less than about one hundred sixty percent (160%) of the light valve size, or less than about one hundred forty percent (140%) of the light valve size, or less than about one hundred twenty percent (120%) of the light valve size. For example, by ‘comparable size’, the multibeam element size may be between about seventy-five percent (75%) and about one hundred fifty percent (150%) of the light valve size. In another example, the multibeam element 120 may be comparable in size to the light valve size, where the multibeam element size is between about one hundred twenty-five percent (125%) and about eighty-five percent (85%) of the light valve size. According to some embodiments, the comparable sizes of the multibeam element 120 and the light valve 130 may be chosen to reduce, or in some examples to minimize, dark zones between views of the multiview display. Moreover, the comparable sizes of the multibeam element 120 and the light valve 130 may be chosen to reduce, and in some examples to minimize, an overlap between views (or view pixels) of a multiview display or of a multiview image displayed by the multiview display.

The multiview backlight 100 illustrated in FIGS. 3A-3C may be employed in a multiview display further comprises an array of light valves 130 configured to modulate the directional light beams 102 of the directional light beam plurality. As illustrated in FIGS. 3A-3C, different ones of the directional light beams 102 having different principal angular directions pass through and may be modulated by different ones of the light valves 130 in the light valve array. Further, as illustrated, a set of the light valves 130 corresponds to a multiview pixel 106 of the multiview display, and a selected light valve 130 of the set corresponds to a view pixel. In particular, a different set of light valves 130 of the light valve array is configured to receive and modulate the directional light beams 102 from a corresponding one of the multibeam elements 120, i.e., there is one unique set of light valves 130 for each multibeam element 120, as illustrated. In various embodiments, different types of light valves may be employed as the light valves 130 of the light valve array including, but not limited to, one or more of liquid crystal light valves, electrophoretic light valves, and light valves based on electrowetting.

As illustrated in FIG. 3A, a first light valve set 130a is configured to receive and modulate the directional light beams 102 from a first multibeam element 120a. Further, a second light valve set 130b is configured to receive and modulate the directional light beams 102 from a second multibeam element 120b. Thus, each of the light valve sets (e.g., the first and second light valve sets 130a, 130b) in the light valve array corresponds, respectively, both to a different multibeam element 120 (e.g., elements 120a, 120b) and to a different multiview pixel 106, as illustrated in FIG. 3A.

Note that, as illustrated in FIG. 3A, the size of a light valve 130 may correspond to a physical size of a light valve 130 in the light valve array. In other examples, the light valve size may be defined as a distance (e.g., a center-to-center distance) between adjacent light valves 130 of the light valve array. For example, an aperture of the light valves 130 may be smaller than the center-to-center distance between the light valves 130 in the light valve array. Thus, the light valve size may be defined as either the size of the light valve 130 or a size corresponding to the center-to-center distance between the light valves 130, according to various embodiments.

In some embodiments, a relationship between the multibeam elements 120 and corresponding multiview pixels 106 (i.e., sets of light valves 130) may be a one-to-one relationship. That is, there may be an equal number of multiview pixels 106 and multibeam elements 120. FIG. 3B explicitly illustrates by way of example the one-to-one relationship where each multiview pixel 106 comprising a different set of light valves 130 is illustrated as surrounded by a dashed line. In other embodiments (not illustrated), the number of multiview pixels 106 and the number of multibeam elements 120 may differ from one another.

In some embodiments, an inter-element distance (e.g., center-to-center distance) between a pair of multibeam elements 120 of the plurality may be equal to an inter-pixel distance (e.g., a center-to-center distance) between a corresponding pair of multiview pixels 106, e.g., represented by light valve sets. For example, as illustrated in FIG. 3A, a center-to-center distance d between the first multibeam element 120a and the second multibeam element 120b is substantially equal to a center-to-center distance D between the first light valve set 130a and the second light valve set 130b. In other embodiments (not illustrated), the relative center-to-center distances of pairs of multibeam elements 120 and corresponding light valve sets may differ, e.g., the multibeam elements 120 may have an inter-element spacing (i.e., center-to-center distance d) that is one of greater than or less than a spacing (i.e., center-to-center distance D) between light valve sets representing multiview pixels 106.

In some embodiments, a shape of the multibeam element 120 is analogous to a shape of the multiview pixel 106 or equivalently, to a shape of a set (or ‘sub-array’) of the light valves 130 corresponding to the multiview pixel 106. For example, the multibeam element 120 may have a square shape and the multiview pixel 106 (or an arrangement of a corresponding set of light valves 130) may be substantially square. In another example, the multibeam element 120 may have a rectangular shape, i.e., may have a length or longitudinal dimension that is greater than a width or transverse dimension. In this example, the multiview pixel 106 (or equivalently the arrangement of the set of light valves 130) corresponding to the multibeam element 120 may have an analogous rectangular shape. FIG. 3B illustrates a plan view of square-shaped multibeam elements 120 and corresponding square-shaped multiview pixels 106 comprising square sets of light valves 130. In yet other examples (not illustrated), the multibeam elements 120 and the corresponding multiview pixels 106 have various shapes including or at least approximated by, but not limited to, a triangular shape, a hexagonal shape, and a circular shape.

Further (e.g., as illustrated in FIG. 3A), each multibeam element 120 is configured to provide directional light beams 102 to one and only one multiview pixel 106 based on the set of light valves 130 that are assigned to a particular multiview pixel 106, according to some embodiments. In particular, for a given one of the multibeam elements 120 and an assignment of the set of light valves 130 to a particular multiview pixel 106, the directional light beams 102 having different principal angular directions corresponding to the different views of the multiview display are substantially confined to the single corresponding multiview pixel 106 and the single set of light valves 130 corresponding to the multibeam element 120, as illustrated in FIG. 3A. As such, each multibeam element 120 of the multiview backlight 100 provides a corresponding set of directional light beams 102 that has a set of the different principal angular directions corresponding to the different views of the multiview display (i.e., the set of directional light beams 102 contains a light beam having a direction corresponding to each of the different view directions).

According to various embodiments, a viewing distance 136 of the multiview display that includes the multiview backlight 100 may be defined as a distance VD from the array of light valves 130 in the multiview display where a separation of different views of the multiview display is approximately equal to a human interocular (IO) distance 134. The viewing distance 136 may correspond to or may be a function of a distance 132 between the array of light valves 130 and effective light sources in the multiview display (i.e., the multibeam elements 120). Notably, the viewing distance 136 may be a product of the human interocular (IO) distance 134 and the distance 132, divided by a product of a size of a light valve 130 in multiview pixels 106 and an average index of refraction over the distance 132. Therefore, the viewing distance 136 may increase as the distance 132 increases or as the size of a light valve 130 decreases. However, as a consequence, the viewing distance 136 may be increased for a multiview display having a high resolution.

In order to reduce or maintain the viewing distance 136, such as when the light valve size of the multiview display is reduced, multibeam elements 120 may be disposed proximal to the first (or front) surface 110′ of the light guide 110, as opposed to second (or back) surface 110″.

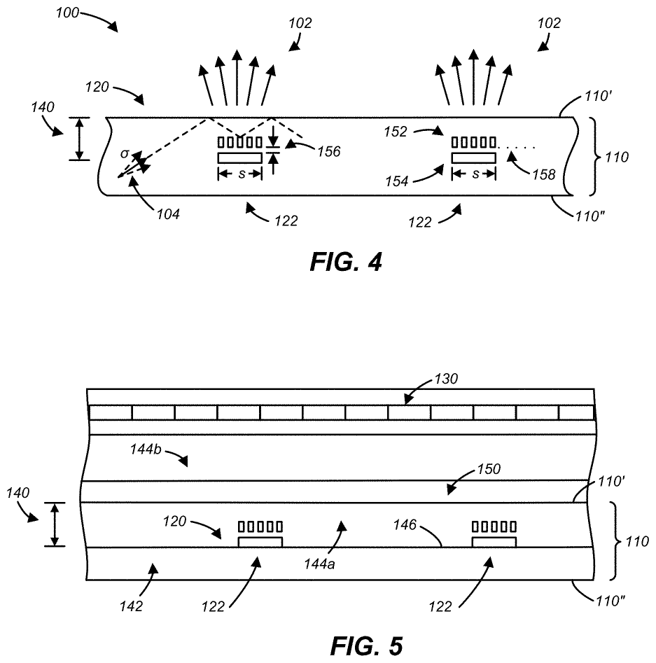

A variation on this configuration is illustrated in FIG. 4, which presents a cross-sectional view of a multiview backlight 100 in an example, according to an embodiment consistent with the principles described herein. Notably, multibeam elements 120 may be located within the light guide 110 a predetermined distance 140 below the first surface 110′. The multibeam elements 120 may be configured to scatter out through the first surface 110′ a portion of the guided light 104 as a plurality of directional light beams 102 having different principal angular directions corresponding to different views of a multiview display. As shown in FIG. 4, the predetermined distance 140 may be greater than one quarter (25%) of a size of a light valve in the array of light valves 130 of the multiview display that employs the multiview backlight 100. For example, the predetermined distance 140 may be about fifty microns (50 μm). Moreover, the predetermined distance 140 may be comparable to the size of one of the multibeam elements 120. Furthermore, a multibeam element (such as the first multibeam element 120a) in the multibeam elements 120 may be between one quarter and two times the light valve size in the array of light valves 130. In other embodiments the multibeam element 120 may be between one half and two times the light valve size.

One approach for implementing the configuration in FIG. 4 is shown in FIG. 5, which illustrates a cross-sectional view of a multiview display in an example, according to an embodiment consistent with the principles described herein. In particular, the light guide 110 may include the first material layer 142 and the second material layer 144a disposed on a surface 146 of the first material layer 142. The second material layer 144a may have a refractive index that is matched to a refractive index of the first material layer 142. Moreover, the multibeam elements 120 may be disposed on the surface 146 of the first material layer 142 and the predetermined distance 140 may be determined by a thickness of the second material layer 144a.

For example, the first material layer 142 may include a glass plate and the multibeam elements 120 may be disposed on the surface 146 of the glass plate. Moreover, the second material layer 144a may have a top surface, i.e., the first surface 110′. The second material layer 144a may include an adhesive that is transparent to the guided light 104, such as an optically clear adhesive (OCA), which is mechanically coupled to the glass plate and the multibeam elements 120, and which may have the thickness equal to the predetermined distance 140. Alternatively, an optically clear resin may be used instead of or in addition to an OCA, in some embodiments. In various embodiments, OCAs and other optically clear resins may include, but are not limited to, various acrylic-based and silicone-based optical materials used in conjunction with the manufacture of liquid crystal displays and touch panels, for example. The second material layer 144a may include an OCA or a similar optically clear resin that is deposited on the first material layer 142 as a liquid that is subsequently cured or as a preformed, substantially solid material film or tape.

Moreover, in some embodiments the multiview display may include an optional low-index layer 150 disposed between and connecting the array of light valves 130 and the light guide 110. Notably, the low-index layer 150 may be disposed on the first surface 110′. The low-index layer 150 may include a material having an index of refraction that is less than an index of refraction of a material of the light guide 110. For example, the low-index layer 150 may have an index of refraction that is less than about 1.2 (and, more generally, more than 0.1 to 0.2 less than the index of refraction of the light guide 110) and/or may have a thickness of about one micron (1 μm). In some embodiments, the low-index layer 150 includes an IOC-560 anti-reflective coating (from Inkron of Espoo, Finland) or a CEF2801 to CEF2810 contrast enhancement film (from 3M of Minneapolis, Minn.). Note that the material in the low-index layer 150 may be configured to ensure total internal reflection of the guided light 104 in the light guide 110.

In some embodiments with the low-index layer 150, the multiview display may include an optional third material layer 144b disposed on top of the low-index layer 150, and between and connecting the low-index layer 150 and the array of light valves 130. This third material layer 144b may be another instance of the second material layer 144a. Consequently, the third material layer 144b may include the adhesive that is transparent to the guided light 104 (such as the optically clear adhesive or OCA), and may be mechanically coupled to the low-index layer 150 and the array of light valves 130. In some embodiments, the array of light valves 130 may be laminated onto the third material layer 144b.

Referring back to FIG. 4, the multibeam elements 120 may include diffraction gratings 122 configured to diffractively scatter out the portion of the guided light 104 (which may be white light or RGB) as the plurality of directional light beams 102. For example, a diffracting grating in the diffraction gratings 122 may include a grating layer 152 and a reflector layer 154. Moreover, the reflector layer 154 may be separate (or detached) from and adjacent to a side 158 of the grating layer 152 that is opposite to surface 146. Thus, the diffraction grating may be a reflection mode diffraction grating configured to diffractively scatter and reflect the guided light portion toward the first surface 110′ of the light guide 110.

In some embodiments, the grating layer 152 may include a metal (or a metal island) or a dielectric, such as silicon nitride or titanium oxide. Moreover, the grating layer 152 may have an index of refraction that is greater than 1.8. Furthermore, reflector layer 154 may include a metal or a distributed Bragg reflector (DBR). In order for the grating layer 152 to be accessible to input light, there may be an optional separation 156 between the grating layer 152 and the reflector layer 154. This separation may be approximately the size of the diffraction grating 122 (and, thus, of a light valve size in the array of light valves 130).

Note that the grating layer 152 may include a plurality of diffractive features spaced apart from one another by a diffractive feature spacing (which is sometimes referred to as a ‘grating spacing’) or a diffractive feature or grating pitch configured to provide diffractive coupling out of the guided light portion. According to various embodiments, the spacing or grating pitch of the diffractive features in the diffraction grating 122 may be sub-wavelength (i.e., less than a wavelength of the guided light). Note that, while FIG. 4 illustrates the diffraction grating 122 having a single grating spacing (i.e., a constant grating pitch), for simplicity of illustration. In various embodiments, the diffraction grating 122 may include a plurality of different grating spacings (e.g., two or more grating spacings) or a variable grating spacing or pitch to provide the directional light beams. Consequently, FIG. 4 does not imply that a single grating pitch is an embodiment of the diffraction grating 122.

While FIG. 4 illustrates the diffraction grating 122 as a reflection mode diffraction grating, in other embodiments the diffraction grating 122 may be a transmission mode diffraction grating or both a reflection mode diffraction grating and a transmission mode diffraction grating. Note that, in some embodiments described herein, the principal angular directions of the plurality of directional light beams 102 may include an effect of refraction due to the plurality of directional light beams 102 exiting the light guide 110 at the surface 146, such as when the index of refraction of the first material layer 142 and the second material layer 144a are not perfectly matched.

According to some embodiments, the diffractive features of the diffraction grating 122 may comprise one or both of grooves and ridges that are spaced apart from one another. The grooves or the ridges may comprise a material of the light guide 110, e.g., may be formed in a surface of the light guide 110 or the surface 146. In another example, the grooves or the ridges may be formed from a material other than the light guide material, e.g., a film or a layer of another material on a surface of the light guide 110. Note that grating characteristics (such as grating pitch, groove depth, ridge height, etc.) and/or a density of diffraction gratings along an axis (e.g., x-axis) may be used to compensate for a change in optical intensity of the guided light 104 within the light guide 110 as a function of propagation distance, according to some embodiments.

In some embodiments, the diffraction grating 122 of the multibeam element 120 is a uniform diffraction grating in which the diffractive feature spacing is substantially constant or unvarying throughout the diffraction grating 122. In some embodiments (not illustrated), the diffraction grating 122 configured to provide the directional light beams 102 is or comprises a variable or chirped diffraction grating. By definition, the ‘chirped’ diffraction grating is a diffraction grating exhibiting or having a diffraction spacing of the diffractive features (i.e., the grating pitch) that varies across an extent or length of the chirped diffraction grating. In some embodiments, the chirped diffraction grating may have or exhibit a chirp of the diffractive feature spacing that varies linearly with distance. As such, the chirped diffraction grating is a ‘linearly chirped’ diffraction grating, by definition. In other embodiments, the chirped diffraction grating of the multibeam element 120 may exhibit a non-linear chirp of the diffractive feature spacing. Various non-linear chirps may be used including, but not limited to, an exponential chirp, a logarithmic chirp or a chirp that varies in another, substantially non-uniform or random but still monotonic manner. Non-monotonic chirps such as, but not limited to, a sinusoidal chirp or a triangle or sawtooth chirp, may also be employed. Combinations of any of these types of chirps may also be employed.

Referring again to FIG. 3A, the multiview backlight 100 may further comprise a light source 160. According to various embodiments, the light source 160 is configured to provide the light to be guided within light guide 110. In particular, the light source 160 may be located adjacent to an entrance surface or end (input end) of the light guide 110. In various embodiments, the light source 160 may comprise substantially any source of light (e.g., optical emitter) including, but not limited to, an LED, a laser (e.g., laser diode) or a combination thereof. In some embodiments, the light source 160 may comprise an optical emitter configured produce a substantially monochromatic light having a narrowband spectrum denoted by a particular color. In particular, the color of the monochromatic light may be a primary color of a particular color space or color model (e.g., a red-green-blue (RGB) color model). In other examples, the light source 160 may be a substantially broadband light source configured to provide substantially broadband or polychromatic light. For example, the light source 160 may provide white light. In some embodiments, the light source 160 may comprise a plurality of different optical emitters configured to provide different colors of light. The different optical emitters may be configured to provide light having different, color-specific, non-zero propagation angles of the guided light corresponding to each of the different colors of light.

In some embodiments, the light source 160 may further comprise a collimator. The collimator may be configured to receive substantially uncollimated light from one or more of the optical emitters of the light source 160. The collimator is further configured to convert the substantially uncollimated light into collimated light. In particular, the collimator may provide collimated light having the non-zero propagation angle and being collimated according to a predetermined collimation factor, according to some embodiments. Moreover, when optical emitters of different colors are employed, the collimator may be configured to provide the collimated light having one or both of different, color-specific, non-zero propagation angles and having different color-specific collimation factors. The collimator is further configured to communicate the collimated light beam to the light guide 110 to propagate as the guided light 104, described above.

In some embodiments, the multiview backlight 100 is configured to be substantially transparent to light in a direction through the light guide 110 orthogonal to (or substantially orthogonal) to a propagation direction 103 of the guided light 104. In particular, the light guide 110 and the spaced apart multibeam elements 120 allow light to pass through the light guide 110 through both the first surface 110′ and the second surface 110″, in some embodiments. Transparency may be facilitated, at least in part, due to both the relatively small size of the multibeam elements 120 and the relatively large inter-element spacing (e.g., one-to-one correspondence with the multiview pixels 106) of the multibeam element 120. Further, the diffraction gratings 122 of the multibeam elements 120 may also be substantially transparent to light propagating orthogonal to the light guide surfaces 110′, 110″, according to some embodiments.

While the preceding discussion illustrated the multibeam elements 120 as diffraction gratings, in other embodiments a wide variety of optical components are used to generate the directional light beams 102, including micro-reflective components that are configured to reflectively scatter out the portion of the guided light 104 and/or micro-refractive components that are configured to refractively scatter out the portion of the guided light 104 as the plurality of directional light beams 102. For example, the micro-reflective components may include a triangular-shaped mirror, a trapezoid-shaped mirror, a pyramid-shaped mirror, a rectangular-shaped mirror, a hemispherical-shaped mirror, a concave mirror and/or a convex mirror. Note that these optical components may be located the predetermined distance 140 from the first surface 110′ of the light guide 110. More generally, an optical component may be disposed on the first surface 110′ or between the first surface 110′ and the second surface 110″. Furthermore, an optical component may be a ‘positive feature’ that protrudes out from the first surface 110′ or the surface 146, or it may be a ‘negative feature’ that is recessed into the first surface 110′ or the surface 146.

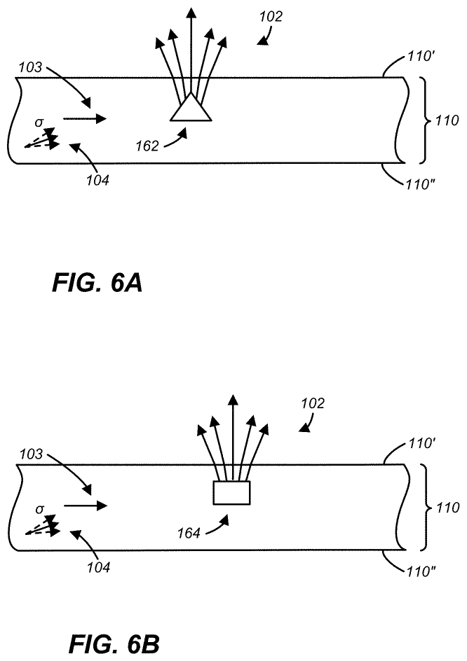

FIG. 6A illustrates a cross-sectional view of a multibeam element 120, which may be included in a multiview backlight, in an example, according to an embodiment consistent with the principles described herein. In particular, FIG. 6A illustrates various embodiments of the multibeam element 120 comprising a micro-reflective element 162. Micro-reflective elements used as or in the multibeam element 120 may include, but are not limited to, a reflector that employs a reflective material or layer thereof (e.g., a reflective metal) or a reflector based on total internal reflection (TIR). According to some embodiments (e.g., as illustrated in FIG. 6A), the multibeam element 120 comprising the micro-reflective element 162 may be located at or adjacent to a surface (e.g., the first surface 110′) of the light guide 110. In other embodiments (not illustrated), the micro-reflective element 162 may be located within the light guide 110 between the first and second surfaces 110′, 110″ (such as on the surface 146).

For example, FIG. 6A illustrates the multibeam element 120 comprising a micro-reflective element 162 having reflective a facet (e.g., a ‘prismatic’ micro-reflective element) located on the surface 146 in the light guide 110. The facets of the illustrated prismatic micro-reflective element 162 are configured to reflect (i.e., reflectively couple) the portion of the guided light 104 out of the light guide 110. The facets may be slanted or tilted (i.e., have a tilt angle) relative to a propagation direction of the guided light 104 to reflect the guided light portion out of light guide 110, for example. The facets may be formed using a reflective material within the light guide 110 (e.g., as illustrated in FIG. 6A) or may be surfaces of a prismatic cavity in the first surface 110′, according to various embodiments. When a prismatic cavity is employed, either a refractive index change at the cavity surfaces may provide reflection (e.g., TIR reflection) or the cavity surfaces that form the facets may be coated by a reflective material to provide reflection, in some embodiments. FIG. 6A also illustrates the guided light 104 having a propagation direction 103 (i.e., illustrated as a bold arrow), by way of example and not limitation. In another example (not shown), the micro-reflective element may have a substantially smooth, curved surface such as, but not limited to, a semi-spherical micro-reflective element. In some embodiments, the micro-reflective element 162 has a surface roughness, so that the scattering of the directional light beams 102 is other than specular. However, in some embodiments, the scattering of the directional light beam 102 by micro-reflective element 162 is specular.

FIG. 6B illustrates a cross-sectional view of a multibeam element 120, which may be included in a multiview backlight, in an example, according to another embodiment consistent with the principles described herein. In particular, FIG. 6B illustrates a multibeam element 120 comprising a micro-refractive element 164. According to various embodiments, the micro-refractive element 164 is configured to refractively couple out a portion of the guided light 104 from the light guide 110. That is, the micro-refractive element 164 is configured to employ refraction (e.g., as opposed to diffraction or reflection) to couple out the guided light portion from the light guide 110 as the directional light beams 102, as illustrated in FIG. 6B. The micro-refractive element 164 may have various shapes including, but not limited to, a semi-spherical shape, a rectangular shape or a prismatic shape (i.e., a shape having sloped facets). According to various embodiments, the micro-refractive element 164 may extend or protrude out of a surface (e.g., the first surface 110′ or the surface 146) of the light guide 110, as illustrated, or may be a cavity in the surface (not illustrated). Further, the micro-refractive element 164 may comprise a material of the light guide 110, in some embodiments. In other embodiments, the micro-refractive element 164 may comprise another material adjacent to, and in some examples, in contact with the light guide surface.

In accordance with some embodiments of the principles described herein, a multiview display is provided. The multiview display is configured to emit modulated light beams as pixels of the multiview display. The emitted, modulated light beams have different principal angular directions from one another (also referred to as ‘differently directed light beams’ herein). Further, the emitted, modulated light beams may be preferentially directed toward a plurality of viewing directions of the multiview display. In non-limiting examples, the multiview display may include four-by-four (4×4), four-by-eight (4×8) or eight-by-eight (8×8) views with a corresponding number of view directions. In some examples, the multiview display is configured to provide or ‘display’ a 3D or a multiview image. Different ones of the modulated, differently directed light beams may correspond to individual pixels of different ‘views’ associated with the multiview image, according to various examples. The different views may provide a ‘glasses free’ (e.g., autostereoscopic) representation of information in the multiview image being displayed by the multiview display, for example.

Further, according to various embodiments, the multiview display has a reduced viewing distance. Notably, the multiview display comprises a multiview backlight with a light guide that includes a plurality of multibeam elements. The multibeam elements are configured to provide directional light beams having different principal angular directions corresponding to different view directions of the multiview display. Moreover, the multiview display includes an array of light valves configured to modulate the directional light beams as a multiview image to be displayed by the multiview display. Furthermore, the multibeam elements are located a predetermined distance below a first or top surface of a light guide in the multiview backlight, where the predetermined distance may be greater than one quarter of a size of a light valve of the set of light valves.

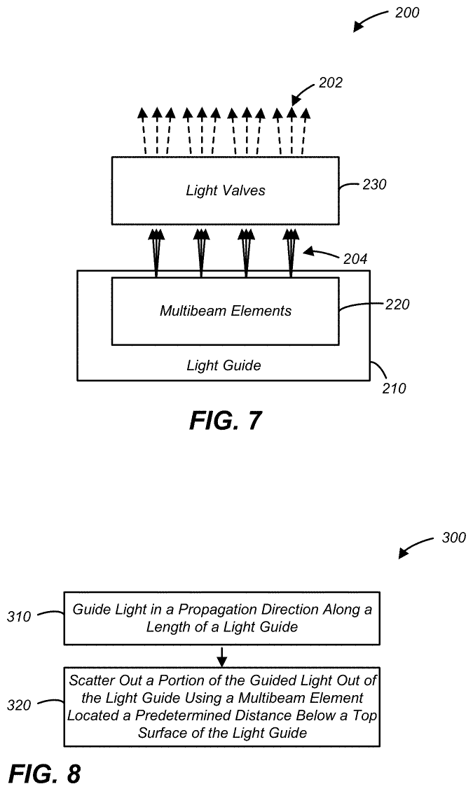

FIG. 7 illustrates a block diagram of a multiview display 200 in an example, according to an embodiment consistent with the principles described herein. According to various embodiments, the multiview display 200 is configured to display a multiview image having different views in different view directions. In particular, modulated light beams 202 emitted by the multiview display 200 are used to display the multiview image and may correspond to pixels of the different views. The modulated light beams 202 are illustrated as arrows emanating from the multiview display 200 in FIG. 7. Dashed lines are used for the arrows of the emitted modulated light beams 202 to emphasize the modulation thereof by way of example and not limitation.

The multiview display 200 illustrated in FIG. 7 comprises a light guide 210. The light guide 210 is configured to guide light. The light may be guided, e.g., as a guided light beam, according to total internal reflection, in various embodiments. For example, the light guide 210 may be a plate light guide configured to guide light from a light-input edge thereof as a guided light beam. In some embodiments, the light guide 210 of the multiview display 200 may be substantially similar to the light guide 110 described above with respect to the multiview backlight 100.

Moreover, in some embodiments, light guide 210 may include a first material layer and a second material layer disposed on a surface of the first material layer and having an index of refraction that matches the index of refraction of the first material layer. According to some embodiments, the predetermined distance may be substantially similar to the predetermined distance 140, described above with respect to the multiview display. Furthermore, according to some embodiments, the first material layer and the second material layer may, respectively, be substantially similar to the first material layer 142 and the second material layer 144a, described above with respect to the multiview display.

According to various embodiments, the multiview display 200 illustrated in FIG. 7 further comprises an array of multibeam elements 220. The multibeam elements 220 may be disposed on a surface of the first material layer. Each multibeam element 220 of the array may comprise a plurality of diffraction gratings configured to provide the plurality of light beams 204 to a corresponding light valve 230. In particular, the plurality of diffraction gratings is configured to diffractively couple out or scatter out a portion of the guided light from the light guide as the plurality of light beams 204. The light beams 204 of the light beam plurality have different principal angular directions from one another. In particular, the different principal angular directions of the light beams 204 correspond to different view directions of respective ones of the different views of the multiview display 200, according to various embodiments.

In some embodiments, the multibeam element 220 of the multibeam element array may be substantially similar to the multibeam element 120 of the multiview backlight 100, described above. For example, the multibeam element 220 may comprise a plurality of diffraction gratings substantially similar to the diffraction gratings 122, described above. In particular, the multibeam elements 220 may be optically coupled to the light guide 210 and configured to couple out or scatter out a portion of the guided light from the light guide as the plurality of light beams 204 provided to the corresponding light valves 230 of the multiview pixel array, according to various embodiments.

As illustrated in FIG. 7, the multiview display 200 further comprises an array of light valves 230. The light valves 230 of the array are configured to provide a plurality of different views of the multiview display 200. According to various embodiments, a light valve 230 of the array comprises a plurality of light valves configured to modulate a plurality of light beams 204 and to produce the emitted modulated light beams 202. In some embodiments, the light valve 230 of the array is substantially similar to the multiview pixel 106 that comprises the set of light valves 130, described above with respect to the multiview display that includes the multiview backlight 100. That is, a light valve 230 of the multiview display 200 may comprises a set of light valves (e.g., a set of light valves 130), and a view pixel may be represented by a light valve (e.g., a single light valve 130) of the set.

Moreover, according to various embodiments, a size of a multibeam element 220 of the multibeam element array is comparable to a size of a light valve of the light valve 230. For example, the size of the multibeam element 220 may be greater than one quarter of the light valve size and less than twice the light valve size, in some embodiments. In addition, an inter-element distance between multibeam elements 220 of the multibeam element array may correspond to an inter-pixel distance between the light valves 230 of the multiview pixel array, according to some embodiments. For example, the inter-element distance between the multibeam elements 220 may be substantially equal to the inter-pixel distance between the light valves 230. In some examples, the inter-element distance between multibeam elements 220 and the corresponding inter-pixel distance between the light valves 230 may be defined as a center-to-center distance or an equivalent measure of spacing or distance.

Furthermore, there may be a one-to-one correspondence between the light valves 230 of the multiview pixel array and the multibeam elements 220 of the multibeam element array. In particular, in some embodiments, the inter-element distance (e.g., center-to-center) between the multibeam elements 220 may be substantially equal to the inter-pixel distance (e.g., center-to-center) between the light valves 230. As such, each light valve in the light valve 230 may be configured to modulate a different one of the light beams 204 of the plurality of light beams 204 provided by a corresponding multibeam element 220. Further, each of the light valves 230 may be configured to receive and modulate the light beams 204 from one and only one multibeam element 220, according to various embodiments.

Moreover, in order to reduce or maintain a viewing distance of the multiview display 200 (such as when the light valves 230 include a high density of light valves, i.e., light valves having a small size or pitch), the multibeam elements 220 may be proximate to a top or first surface of the light guide 210. For example, in some embodiments, the multibeam elements 220 are disposed a predetermined distance below the top or first surface of the light guide 210.

In some of these embodiments (not illustrated in FIG. 7), the multiview display 200 may further comprise a light source. The light source may be configured to provide the light to the light guide 210 with a non-zero propagation angle and, in some embodiments, is collimated according to a collimation factor to provide a predetermined angular spread of the guided light within the light guide 210, for example. According to some embodiments, the light source may be substantially similar to the light source 160, described above with respect to the multiview backlight 100. In some embodiments, a plurality of light sources may be employed. For example, a pair of light sources may be used at two different edges or ends (e.g., opposite ends) of the light guide 210 to provide the light to the light guide 210. In some embodiments, the multiview display 200 comprises the multiview display, described above in conjunction with and including the multiview backlight 100.

In accordance with other embodiments of the principles described herein, a method of multiview backlight operation is provided. FIG. 8 illustrates a flow chart of a method 300 of multiview backlight operation in an example, according to an embodiment consistent with the principles described herein. As illustrated in FIG. 8, the method 300 of multiview backlight operation comprises guiding 310 the light in a propagation direction along a length of the light guide. In some embodiments, the light may be guided at a non-zero propagation angle. Further, the guided light may be collimated, e.g., collimated according to a predetermined collimation factor. According to some embodiments, the light guide may be substantially similar to the light guide 110 described above with respect to the multiview backlight 100. In particular, the light may be guided according to total internal reflection within the light guide, according to various embodiments. Further, in some embodiments, the light guide may comprise a first layer and a second layer having an index of refraction that is matched to and index of refraction of the first layer and being optically connected to a surface of the first layer. In these embodiments, the multibeam elements may be arranged on the surface of the first layer and a thickness of the second layer being configured to provide the predetermined thickness. In some embodiments, the first layer may be substantially similar to the first material layer 142 and the second layer may be substantially similar to the second material layer 144a, described above with respect to the light guide 110.

According to various embodiments, the method 300 of multiview backlight operation further comprises scattering 320 out a portion of the guided light out of a light guide using a multibeam element to provide a plurality of directional light beams having different principal angular directions of different views in a multiview display or equivalently in a multiview image displayed by the multiview display, where the multibeam element is located in the light guide a predetermined distance below a first or top surface of the light guide. In some embodiments, the multibeam element is substantially similar to the multibeam elements 120 of the multiview backlight 100, described above. For example, multibeam elements 120 may comprise one or more of a diffraction grating, a micro-reflective element, or a micro-refractive element that is substantially similar to the above-described diffraction grating 122, the micro-reflective element 162, and the micro-refractive element 164 of the multiview backlight 100.

In some embodiments (not illustrated), the method of multiview backlight operation further comprises modulating the directional light beams to display the multiview image using an array of light valves. Notably, a set of light valves of the light valve array may correspond to a multibeam element of the multibeam element plurality arranged as a multiview pixel and may be configured to modulate directional light beams from the multibeam element. According to some embodiments, a light valve of a plurality or an array of light valves may correspond to a view pixel. According to some embodiments, the plurality of light valves may be substantially similar to the array of light valves 130 described above with respect to FIGS. 3A-3C for the multiview display that includes the multiview backlight 100. In particular, different sets of light valves may correspond to different multiview pixels in a manner similar to the correspondence of the first and second light valve sets 130a, 130b to different multiview pixels 106, as described above. Further, individual light valves of the light valve array may correspond to individual view pixels as is also described above.

In some embodiments (not illustrated), the method of multiview backlight operation further comprises providing light to the light guide using a light source. The provided light one or both of may have a non-zero propagation angle within the light guide. Further, the guided light may be collimated, e.g., collimated according to a predetermined collimation factor. According to some embodiments, the light source may be substantially similar to the light source 160 described above with respect to the multiview backlight 100.

Thus, there have been described examples and embodiments of a multiview backlight, a method of multiview backlight operation, a multiview backlight that employ multibeam elements to provide light beams corresponding to plurality of different views of a multiview image, and a multiview display that includes the multiview backlight. Further, in order to reduce or maintain the viewing distance of the multiview display, such as when the multiview display has high resolution, the multiview backlight may employ an array of multibeam elements configured to provide directional light beams having different principal angular directions corresponding to the different view directions of the multiview display. The multibeam elements may be located a predetermined distance below a surface of a light guide in the multiview backlight in the multiview display. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A multiview backlight, comprising:
a light guide, having a top surface, configured to guide light in a propagation direction along a length of the light guide; and
a multibeam element located within the light guide a predetermined distance below the top surface, the multibeam element being configured to scatter out through the top surface a portion of the guided light as a plurality of directional light beams having different principal angular directions corresponding to different views of a multiview display,
wherein the predetermined distance is greater than one quarter of a size of a light valve of a multiview display that employs the multiview backlight, and wherein a size of the multibeam element is between one quarter and two times the light valve size.

2. The multiview backlight of claim 1, wherein the predetermined distance is comparable to the size of the multibeam element.

3. The multiview backlight of claim 1, wherein the light guide comprises a first material layer and a second material layer disposed on a surface of the first material layer, the second material layer having a refractive index that is matched to a refractive index of the first material layer, and wherein the multibeam element is disposed on the first material layer surface, the predetermined distance being determined by a thickness of the second material layer.

4. The multiview backlight of claim 3, wherein the first material layer comprises a glass plate and the multibeam element is disposed on a surface of the glass plate; and
wherein the second material layer has the top surface and comprises an adhesive transparent to the guided light, the second material layer being mechanically coupled to the glass plate and the multibeam element and having a thickness equal to the predetermined distance.

5. The multiview backlight of claim 1, wherein the multibeam element comprises a diffraction grating configured to diffractively scatter out the portion of the guided light as the plurality of directional light beams.

6. The multiview backlight of claim 5, wherein the diffraction grating comprises a reflection mode diffraction grating configured to both diffractively scatter and reflect the guided light portion toward the top surface of the light guide.

7. The multiview backlight of claim 6, wherein the reflection mode diffraction grating comprises a grating layer and a reflector layer adjacent to a side of the grating layer opposite to the top surface.

8. The multiview backlight of claim 1, wherein the multibeam element comprises one or both of a micro-reflective element and a micro-refractive element, the micro-reflective element being configured to reflectively scatter out the portion of the guided light and the micro-refractive element being configured to refractively scatter out the portion of the guided light as the plurality of directional light beams.

9. The multiview backlight of claim 1, further comprising a light source optically coupled to an input of the light guide, the light source being configured to provide the guided light, wherein the guided light has one or both of a non-zero propagation angle and is collimated according to a predetermined collimation factor.

10. A multiview display comprising the multiview backlight of claim 1, the multiview display further comprising an array of light valves disposed adjacent to the top surface of the light guide, the array of light valves being configured to modulate directional light beams of the plurality of directional light beams, a set of light valves of the array corresponding to a multiview pixel of the multiview display.

11. A multiview display comprising:
a light guide having a first layer and a second layer disposed on a surface of the first layer and refractive index matched to the first layer, the light guide being configured to guide light as guided light;
an array of multibeam elements disposed on the surface of the first layer of the light guide, a multibeam element of the array of multibeam elements being configured to scatter out a plurality of directional light beams having directions corresponding to different view directions of the multiview display; and
an array of light valves configured to modulate the plurality of directional light beams of different views of a multiview image corresponding to the different view directions of the multiview display.

12. The multiview display of claim 11, wherein a thickness of the second layer corresponds to a predetermined distance between a top surface of the light guide and the array of multibeam elements, the predetermined distance being greater than a quarter of a size of a light valve of the array of light valves.

13. The multiview display of claim 11, wherein the multibeam element comprises one or more of a diffraction grating configured to diffractively scatter out a portion of the guided light as the plurality of directional light beams, a micro-reflective element configured to reflectively scatter out a portion of the guided light as the plurality of directional light beams, and a micro-refractive element being configured to refractively scatter out a portion of the guided light as the plurality of directional light beams.

14. The multiview display of claim 13, wherein the diffraction grating comprises a reflection mode diffraction grating configured to both diffractively scatter and reflect the guided light portion toward a top surface of the light guide.

15. The multiview display of claim 13, wherein the array of multibeam elements is a predetermined distance below a top surface of the second layer, the predetermined distance being greater than one quarter of a size of a light valve in the array of light valves.

16. The multiview display of claim 15, wherein the first layer comprises a glass plate, the second layer comprises an adhesive layer transparent to the guided light and mechanically coupled to the glass plate; and
wherein the array of multibeam elements is disposed on a surface of the glass plate adjacent the second layer, the second layer having a thickness equal to the predetermined distance.

17. The multiview display of claim 11, further comprising a low-refractive index layer disposed between and connecting the array of light valves and the light guide, the low-index layer comprising a material having an index of refraction that is less than an index of refraction of a material of the light guide and that is configured to ensure total internal reflection of the guided light in the light guide.

18. The multiview display of claim 11, wherein a viewing distance of the multiview display corresponds to a predetermined distance of the array of multibeam elements below a top surface of the second layer and an interocular distance.

19. A method of multiview backlight operation, the method comprising:
guiding light in a propagation direction along a length of a light guide; and
scattering out a portion of the guided light out of the light guide using a multibeam element to provide a plurality of directional light beams having different principal angular directions of different views of a multiview image displayed on a multiview display, the multibeam element being located within the light guide at a predetermined distance below a top surface of the light guide, wherein the predetermined distance is greater than one quarter of a size of a light valve of the multiview display that employs the multiview backlight.

20. The method of multiview backlight operation of claim 19, wherein the light guide comprises a first material layer and a second material layer disposed on a surface of the first material layer, the second material layer having a refractive index that is matched to a refractive index of the first material layer, the predetermined distance is determined by a thickness of the second material layer.
